(19) United States
(12) Patent Application Publication
(10) Pub. No.: US 2015/0134500 A1
(43) Pub. Date: May 14, 2015

(54) Logging Transaction Tracking Systems and Methods

(71) Applicant: Zac Hindman, Northport, AL (US)

(72) Inventor: Zac Hindman, Northport, AL (US)

(21) Appl. No.: 14/540,662

(22) Filed: Nov. 13, 2014

Related U.S. Application Data
(60) Provisional application No. 61/903,692, filed on Nov. 13, 2013.

(51) Int. Cl. G06Q 40/00; G06Q 50/02; G06Q 20/04

(52) U.S. Cl. CPC G06Q 40/12; G06Q 20/0457; G06Q 50/02
USPC 705/30

(57) ABSTRACT

A transaction tracking system of the present disclosure for tracking a transaction for harvesting timber has a mill computing device that receives delivery data indicative of a delivery of timber, receives data describing the delivery of the timber by a logger, and transmits ticket data indicative of the delivery of the timber by the logger. In addition, the system has a logger computing device that receives the data indicative of the ticket and determines, based upon the ticket data, a price to be paid to the logger.

### CROSS REFERENCE TO RELATED APPLICATION

This application claims priority to U.S. Provisional Patent Application Ser. No. 61/903,692 entitled Transaction Tracking System and Method filed on Nov. 13, 2013, which is incorporated herein by reference.

### BACKGROUND

In the logging industry, there is typically a land owner that owns a tract of land to be harvested. Further, there are timber buyers that purchase from the land owner the right to harvest the timber on the tract of land.

In the ordinary course of business, the timber buyer hires a logger that has the equipment to harvest the timber on the tract of land. Thus, the timber buyer and the logger enter into a transaction wherein the timber buyer gives the logger the right to harvest the timber, and the logger agrees to cut timber on the tract of land and deliver the cut timber to a particular, identified timber mill.

In addition to the transactions with the land owner and the logger, the timber buyer also enters into a transaction with the timber mill. In this regard, the timber buyer agrees with the timber mill to deliver a specified tonnage of timber by the logger.

Upon delivery of the timber to the timber mill, the timber mill gives to the logger a paper ticket that verifies delivery. The ticket usually identifies information that includes the mill to which the timber was delivered, the tonnage of the timber delivered, and the product delivered. In this regard, the product may be a particular type of timber, e.g., cedar. Additionally, the ticket identifies cull and overweight amounts. Note that the term cull refers to timber that is rotten or rejected for some other reason. Further note that the term overweight refers to an amount delivered by the logger that exceeds the tonnage agreed to between the timber buyer and the mill.

Ordinarily, the mill pays the timber buyer an agreed to price per ton for the timber delivered. The ultimate price may be an adjusted price in that the timber mill pays the timber buyer based upon the tonnage delivered that is useable, i.e., subtracting out the cull and the overweight.

Further, the logger presents the ticket received from the timber mill to the timber buyer, and the timber buyer compensates the logger for his labor based on the information contained on the ticket. In this regard, the timber buyer pays the logger based upon the useable tonnage of timber that was delivered to the timber mill.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a diagram depicting a transaction tracking system in accordance with an embodiment of the present disclosure.

FIG. 2 is a diagram depicting an exemplary logger computing device of the system depicted in FIG. 1.

FIG. 3 is a diagram depicting an exemplary timber buyer computing device of the system depicted in FIG. 1.

FIG. 4 is an illustration of an exemplary “Setup” graphical user interface (GUI) of the system depicted in FIG. 1.

FIG. 5 is an illustration of an exemplary home GUI of the system depicted in FIG. 1.

FIG. 6 is an illustration of an exemplary “Create New Report” GUI of the system depicted in FIG. 1.

FIG. 7 is an illustration of an exemplary “Buyer Week-End Report” GUI of the system depicted in FIG. 1.

FIG. 8 is an illustration of an exemplary “Logger Week-End Report” GUI of the system depicted in FIG. 1.

FIG. 9 is an illustration of an exemplary “Operating Expenses” GUI of the system depicted in FIG. 1.

FIG. 10 is a flowchart showing exemplary architecture and functionality of the transaction tracking logic of FIGS. 2 and 3.

FIG. 11 is a flowchart depicting exemplary functionality and architecture of the system depicted in FIG. 1.

### DETAILED DESCRIPTION

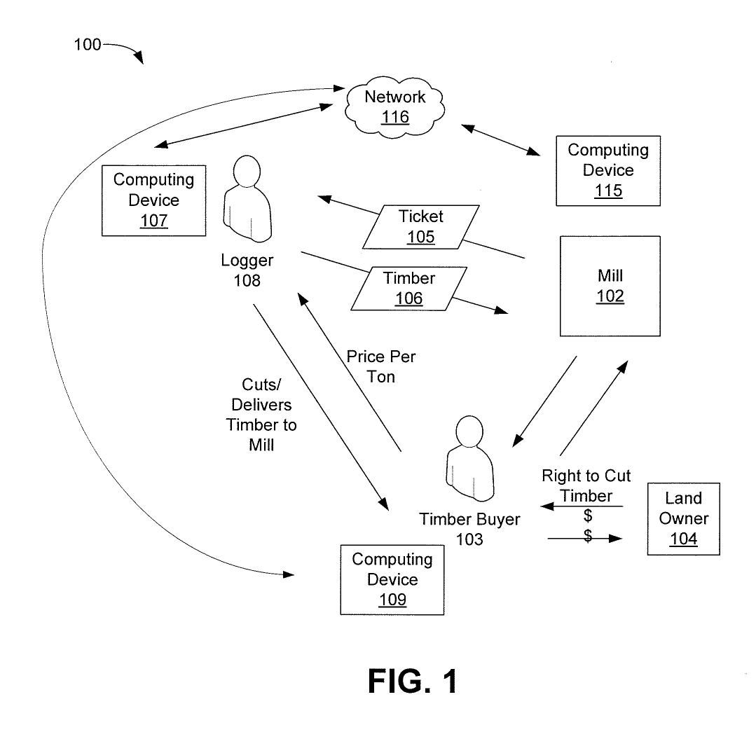

FIG. 1 is a block diagram illustrating an exemplary transaction tracking system 100 in accordance with an embodiment of the present disclosure. The transaction tracking system 100 may involve a number of entities including, but not limited to, a timber mill 102, a logger 108, a timber buyer 103, and a land owner 105. Note that the entities identified in the system 100 depicted in FIG. 1 is for exemplary purposes and additional or fewer entities may be involved in the system in other embodiments.

The exemplary transaction tracking system 100 comprises a logger computing device 107 and a timber buyer computing device 109. The computing devices 107, 109 may be any type of computing device known in the art or future-developed including, but not limited to, a personal computer (PC), a laptop computer, a tablet, a hand-held device, e.g., a smart phone or other personal digital assistant (PDA), or the like.

During a timber transaction, each of the entities 102, 108, 103, and 104 plays a role in the timber transaction. In this regard, the land owner 104 owns a track of land (not shown) on which timber 106 is growing. Note that land owner 104 may represent a single land owner or multiple land owners.

The timber buyer 103 purchases the right from to cut the timber 106 from the land owner's tract of land. The timber buyer 103 enters into an agreement with the mill 102 to deliver a fixed amount of timber (or variable if agreed to) to the mill 102, and the timber buyer 103 enters into an agreement with the logger 108, wherein the logger agrees to cut a particular tonnage of timber from the tract of land, and the timber buyer 103 agrees to pay the logger 108 for useable timber delivered to the mill 102.

The term “useable timber” refers to the amount of timber delivered to the mill 102 that is accepted by the mill for resale. Note that when the logger 108 delivers the timber to the mill 102, the mill 102 may determine that there is a certain amount of the delivered timber that is cull, i.e., rotten or rejected for some other reason. Further, if the mill 102 agreed with the timber buyer 103 to receive a particular tonnage from the logger 108, there may be an overweight tonnage, i.e., tonnage of timber above the amount the mill agreed to accept. The logger 108 is paid by the timber buyer 103 based upon the amount delivered, subtracting out cull and overweight amounts.

In one embodiment, the timber buyer 103 pays the logger a particular agreed to price per ton for the timber 106 that the logger delivers to the mill 102. Note that the logger 108 may actually be two entities, for example, the logger may comprise the company or individual that cuts the wood from the land and a trucker or trucking company that transports the cut timber to the mill 102. For purposes of simplicity, the following discussion assumes that the logger 108 both cuts the timber 106 from the land owner's land and delivers the timber 106 to the mill 102.

During the course of the transaction described hereinabove, various business dealings occur. When the logger 108 delivers the timber 106 to the mill 102, the mill 102 determines how much acceptable timber 106 delivered by the logger 108 is purchased and issues or generates a ticket 105 that the mill 102 provides to the logger 108. Some of the timber delivered may not be of acceptable and quality, e.g., cull. Nonetheless, the mill 102 makes such determination and provides the logger 108 a ticket that identifies, for example, the mill, the tons of timber delivered to the mill, the date of delivery, the time of deliver, the driver of the transport vehicle, if applicable, the type of timber (or product), the cull, and the overweight amount.

Note that the term “cull” refers to timber that is rotten or rejected by the mill 102. Further, the “overweight amount” refers to the tonnage of timber delivered that was not agreed to with the timber buyer, as described hereinabove.

In one embodiment the ticket 105 is a piece of paper or small card that identifies the information listed hereinabove. In another embodiment, the ticket 105 is an electronic data packet that may be transmitted, for example, to the logger computing device 107 and/or the timber buyer computing device 109 that comprises data indicative of the information listed hereinabove. In such an embodiment, the system 100 further comprises a mill computing device 115 with which the mill 102 enters the data indicative of the information and transmits, for example via a network 116, the data to the computing device 107 and/or the computing device 109.

Note that the computing device 107 may be any type of computing device known in the art or future-developed. For purposes of the present disclosure, the computing device 107 may be a personal computer that is connected to the network 116 and configured for receiving the ticket 105 from the computing device 115. In other embodiments, the computing device 107 may be a laptop or notebook computer or a hand-held device, for example a cellular phone or a tablet (e.g., an iPad®).

In addition, the computing device 115 may be any type of computing device known in the art or future developed. The computing device 115 may be, for example, a personal computer, a laptop, a notebook, or a hand-held device, as described hereinabove.

When the computing device 107 and the computing device 115 are hand-held devices, an employee at the mill 102 may tabulate acceptable tonnage delivered and directly transmit the ticket 105 to the computing device 107. In such an embodiment, the network 116 may be a wireless local area network. Additionally, the hand-held devices may communicate via a short-range wireless interconnection, e.g., Bluetooth®.

As will be described further herein, the ticket 105 received by the logger 108 may be used by the computing device 107 to determine various parameters related to the transaction. For example, the computing device 107 determines how much the logger 108 will be paid based upon the information contained in the ticket 105. The computing device 107 may use the ticket 105 for other purposes as well, which are described further herein.

The logger 108 presents the ticket to the timber buyer 103. In one embodiment, the computing device 107 transmits the ticket 105 to the buyer computing device 109. The computing device 109 may perform various tasks based upon the ticket received. For example, the computing device 109 may calculate the amount owed to the logger 108 based upon the information in the ticket 105 and electronically deposit the amount owned the logger 108 in the logger's bank account.

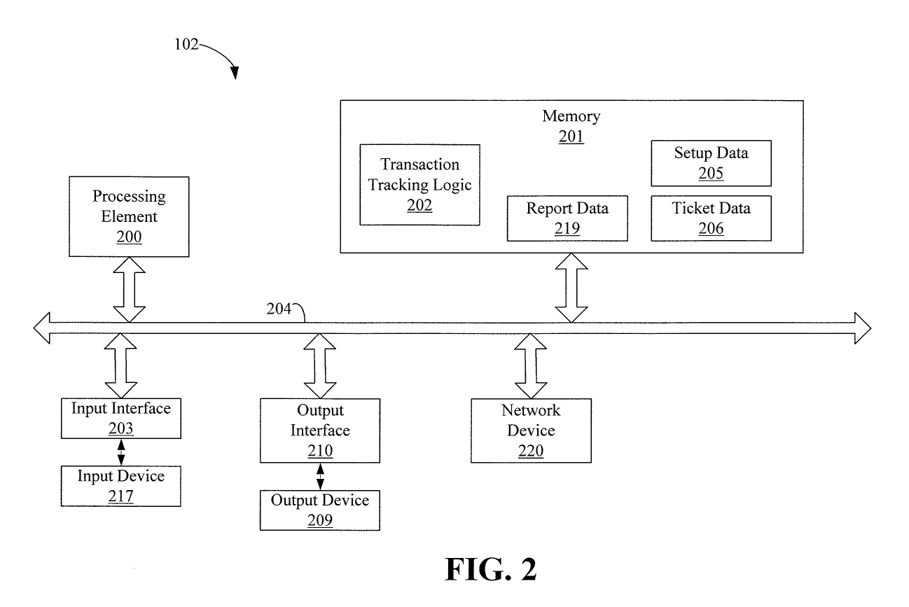

FIG. 2 depicts an exemplary embodiment of logger computing device 107 depicted in FIG. 1. As shown by FIG. 2, the logger computing device 107 comprises transaction tracking logic 202, setup data 205, ticket data 206 and report data 219.

The transaction tracking logic 202 generally controls the functionality of the logger computing device 107, as will be described in more detail hereafter. It should be noted that the transaction tracking logic 202 can be implemented in software, hardware, firmware or any combination thereof. In an exemplary embodiment illustrated in FIG. 2, the transaction tracking logic 202 is implemented in software and stored in memory 201.

Note that the transaction tracking logic 202, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the logger computing device 107 depicted by FIG. 2 comprises at least one conventional processing element 200, such as a digital signal processor (DSP) or a central processing unit (CPU), that communicates to and drives the other components of the logger computing device 107 via a local interface 204, which can include at least one bus. Further, the processing element 200 is configured to execute instructions of software, such as the transaction tracking logic 202.

An input interface 203 may be communicatively coupled to an input device 217, for example, a keyboard, keypad, mouse, optical reader (i.e., for barcodes or QR codes), radio-frequency identification (RFID) readers, etc. The input interface 203 receives signals from the input device 217 indicative of the setup data 205 and the ticket data 206.

Further, an output interface 210 may be communicatively coupled to an output device 209, for example, a printer or display screen (e.g., a liquid crystal display (LCD)). The output interface 210 may be used to transmit signals to the output device 209 indicative of output data to the user. For example, the output interface 210 may transmit report data 219 to the output device 209 for display to a display screen (not shown) or as a printed report to a printer (not shown).

In addition, a network device 220, such as a modem or other type of transceiver, enables the logger computing device 107 to communicate via the network 116 (FIG. 1) to other devices in communication with the network 116. As an example, the network device 220 enables the logger computing device 107 to receive ticket data 206 from the mill computing device 115, and transmit ticket data 206 to the timber buyer computing device 109 (FIG. 1).

As indicated hereinabove, the setup data 205, the ticket data 206, and the report data 210 are stored in memory 201. The ticket data 206 is any type of data received via the network device 220 or captured from the input device 206 or otherwise indicative of those items listed hereinabove related to a deliver to the mill 102 of cut timber 106. As indicated hereinabove, the ticket data 206 may be received from the mill computing device 115 directly, e.g., when the network 116 is a WLAN.

The setup data 205 is any data indicative of the user of the computing device 107 identifies as preferences for the transaction tracking logic 202, etc. The report data 219 comprises data indicative of information to be provided to the user of the computing device 107, such as, for example weekly or monthly totals.

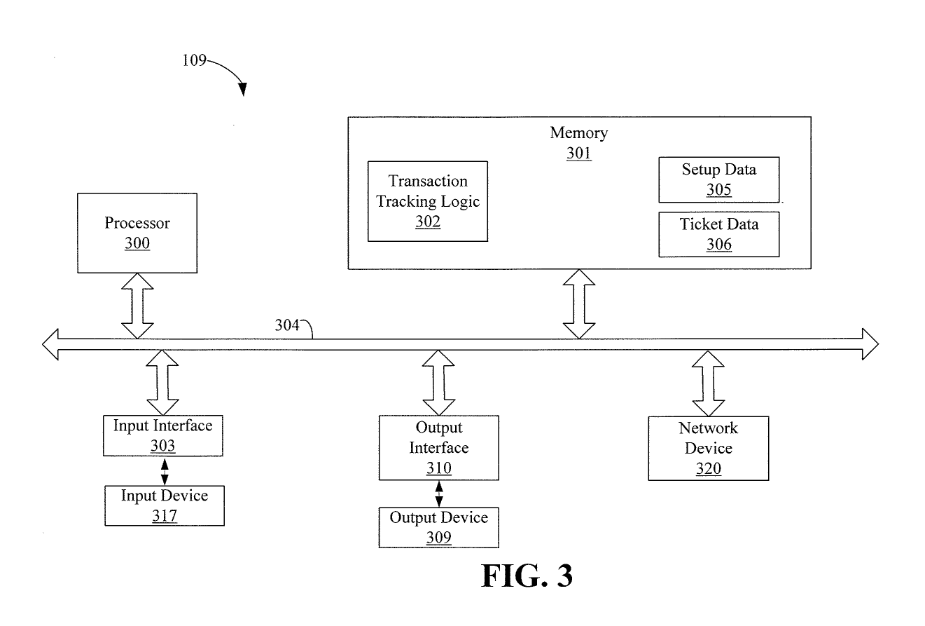

FIG. 3 depicts an exemplary embodiment of timber buyer computing device 109 depicted in FIG. 1. As shown by FIG. 3, the timber buyer computing device 109 comprises transaction tracking logic 302, setup data 305, ticket data 306, and report data 319 substantially similar to the corresponding components of the logger computing device 107.

In addition, the timber buyer computing device 109 has other corresponding components that behave substantially similar to the components of the logger computing device 107. In this regard, the timber buyer computing device 109 comprises a processing element 300 that communicates with the transaction tracking logic 302 over the bus 304. Further, the timber buyer computing device 109 comprises and input interface 303 that communicates with an input device 317, an output interface 310 that communicates with an output device 309, and a network device 320.

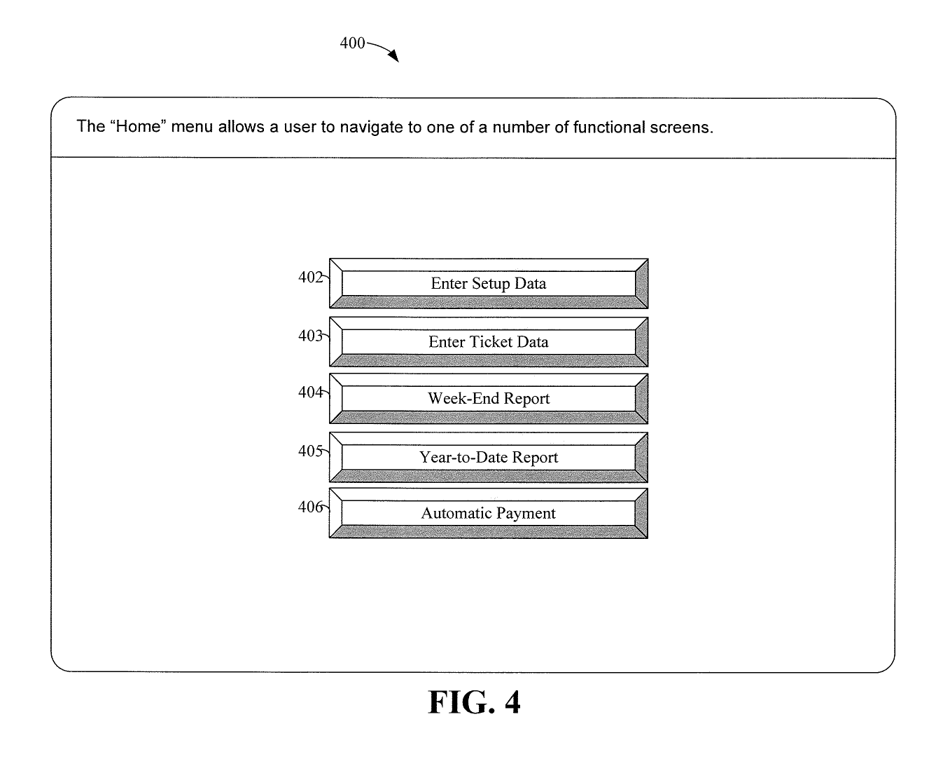

Functionality of the system 100 is now described with reference to each graphical user interfaces (GUI) depicted in respective FIGS. 4-7. For exemplary purposes, the following description is described such that the transaction tracking logic 202 is performing the actions necessary to effectuate the GUI flow. Thus, in the exemplary description following, it is assumed for purposes of the example that the GUIs described are displayed by the transaction tracking logic 202 of the logging computing device 107. Note that the transaction tracking logic 302 of the timber buyer computing device 109 operates substantially similar for tracking transactions.

GUI 400 is a “home” GUI that enables a user to navigate to other functional areas of the transaction tracking logic 302. The “Home” GUI 400 comprises one or more pushbuttons 402-406. In the embodiment depicted, the “Home” GUI 400 comprises an “Enter Setup Data” pushbutton 402, an “Enter Ticket Data” pushbutton 403, a “Week-End Report” pushbutton 404, a “Year-to-Date Report” pushbutton 406, and an “Automatic Payment” pushbutton 406.

GUI 500 is a “Setup” GUI that enables a user to enter data that is saved as setup data 205 and used consistently during operation of the transaction tracking logic 202. The “Setup” GUI 400 comprises one or more pushbuttons 502-505. In the embodiment depicted, the “Setup” GUI 500 comprises an “Enter Mill Data” pushbutton 502, an “Enter Product Data” pushbutton 503, an “Enter Employee Data” pushbutton 504, an “Enter Trucker Data” pushbutton 505, an “Enter Operating Expenses” pushbutton 506, and a “Forecasting” pushbutton 507.

GUI 600 is a “Ticket Data” GUI that enables a user to ticket data 206 (FIG. 2) that is saved in memory 201 (FIG. 2) during operation of the transaction tracking logic 202. The “Ticket Data” GUI 600 comprises one or more text fields 601-608 for entering data indicative of a ticket received from the mill 102 (FIG. 1).

In this regard, in the “Mill” text field 601 the user enters information indicative of the mill 102 to which the timber 106 (FIG. 1) was delivered. In “Tons Delivered” text field 602, the user enters information indicative of the tons of timber 106 delivered to the mill 102 identified in text field 601. In “Date” text field 603, the user enters information indicative of the date the timber 106 was delivered to the mill 102, and in “Time” text field 604, the user enters information indicative of the time the timber 106 was delivered to the mill 102. Further, in “Driver” text field 605, the user enters information indicative of the driver of the truck that delivered the timber 106 to the mill 102, and in “Product” text field 606, the user enters information indicative of the type of timber 106 delivered to the mill 102. In “Cull” text field 607, the user enters information indicative of the tons of timber 106 delivered to the mill 102 that was rejected, and in “Overweight” text field 608, the user enters information indicative of the tons of excess timber 106 delivered to the mill 102.

When the transaction tracking logic 202 displays a “Ticket Data” GUI 600 to the user, the transaction tracking logic 202 automatically generates and displays a unique identifier in field 613 that uniquely identifies the ticket data entered by the user. Further, such unique identifier may be used in memory 201 for indexing the particular ticket data 206 entered.

Further, the “Ticket Data” GUI 600 comprises “Cancel” pushbutton 611 and the “Save” pushbutton 612 that the user can select if he/she either wants to cancel the information entered or save the information entered in ticket data 206.

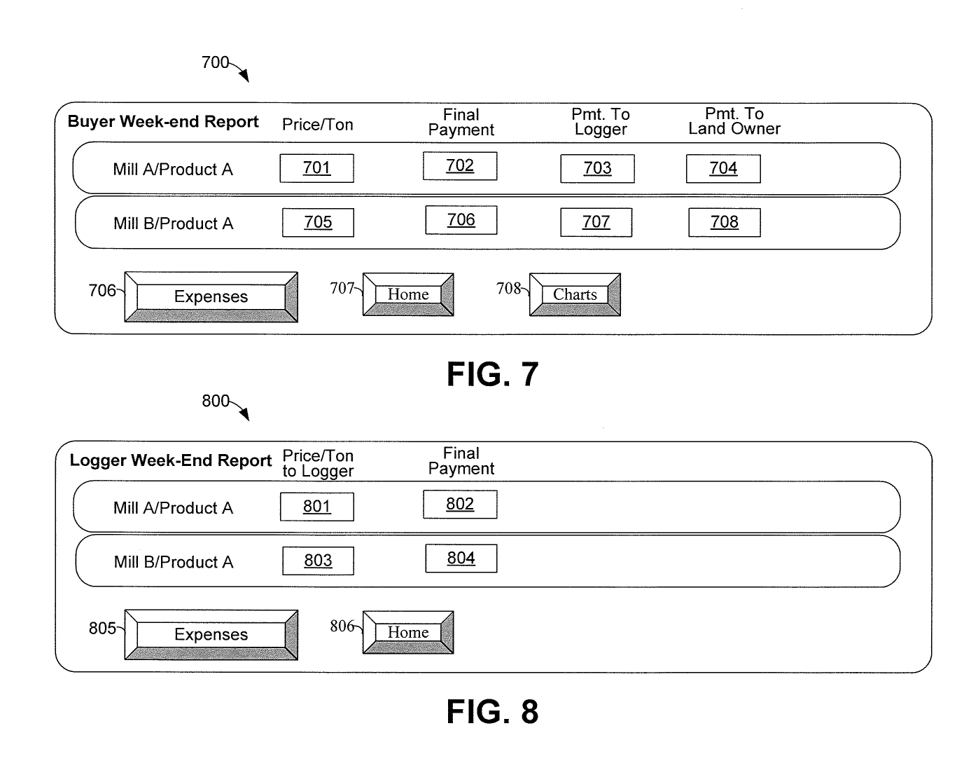

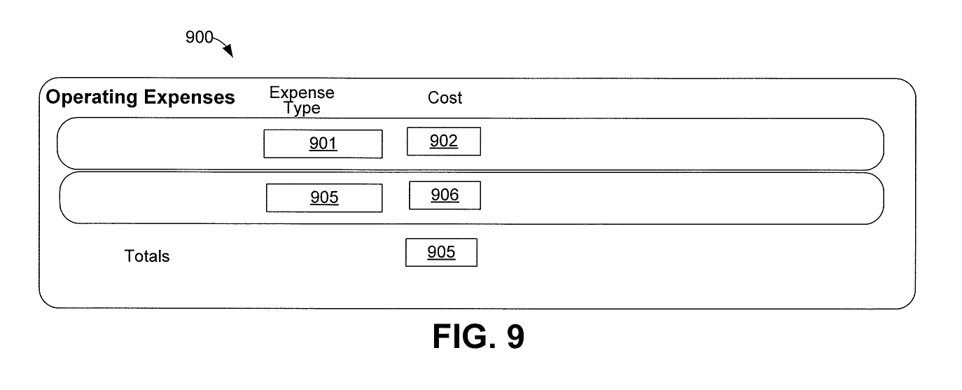

With reference to FIG. 7, GUI 700 is a “Buyer Week-End Report” GUI that displays information to the buyer 103 related to the information entered into the computing device 109 through a particular week. In this regard, the transaction tracking logic may display in text field 701 the price per ton that is contracted with a particular mill 102 for a particular product, i.e., “Mill A/Product A” in text field 701. The transaction tracking logic 302 calculates the final payment to the buyer and displays the calculated data in text field 702. The transaction logic 302 provides such information for each mill and product delivered throughout a week. Additionally, the transaction tracking logic 302 calculates the payment to be made to the logger and displays the calculation in text field 703 and the payment to the land owner in text field 704.

In addition, the GUI 700 may provide an “Expenses” pushbutton 706, and when the pushbutton 706 is selected, the transaction tracking logic 202 displays a GUI 900 in which the buyer can enter data indicative of expenses throughout the week. In this regard, the buyer may enter the expense type in 901 and 905 and the expense cost in 902 and 906, respectively. The logic 302 may further calculate a running total of expenses, and show the total expenses in text field 905.

FIG. 8 is a GUI 800 that may be displayed by the logic 202 when the logger 107 requests a week-end report. In this regard, the logic 202 may display information to the logger 108 related to the information entered into the computing device 107 through a particular week. In this regard, the transaction tracking logic 202 may display in text field 801 the price per ton that is contracted with a particular buyer for a particular product, i.e., “Mill A/Product A” in text field 801. The transaction tracking logic 302 calculates the final payment to the logger and displays the calculated data in text field 802.

In addition, the GUI 800 may provide an “Expenses” pushbutton 806, and when the pushbutton 706 is selected, the transaction tracking logic 202 displays a GUI 900 in which the buyer can enter data indicative of expenses throughout the week.

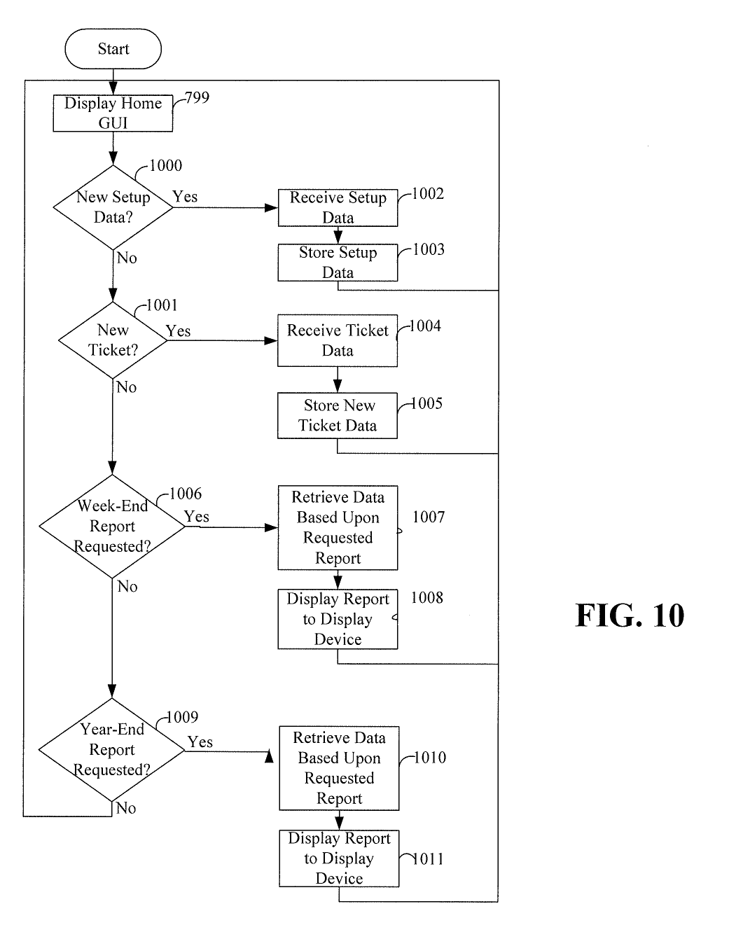

FIG. 10 is a flow chart illustrating exemplary architecture and functionality of the transaction tracking logic 202. When a logger 108 or a timber buyer 103 (hereinafter referred to as “user”) executes the transaction tracking logic 202, the transaction tracking logic 202 displays the “Home” GUI 400 (FIG. 4), as indicated in step 799.

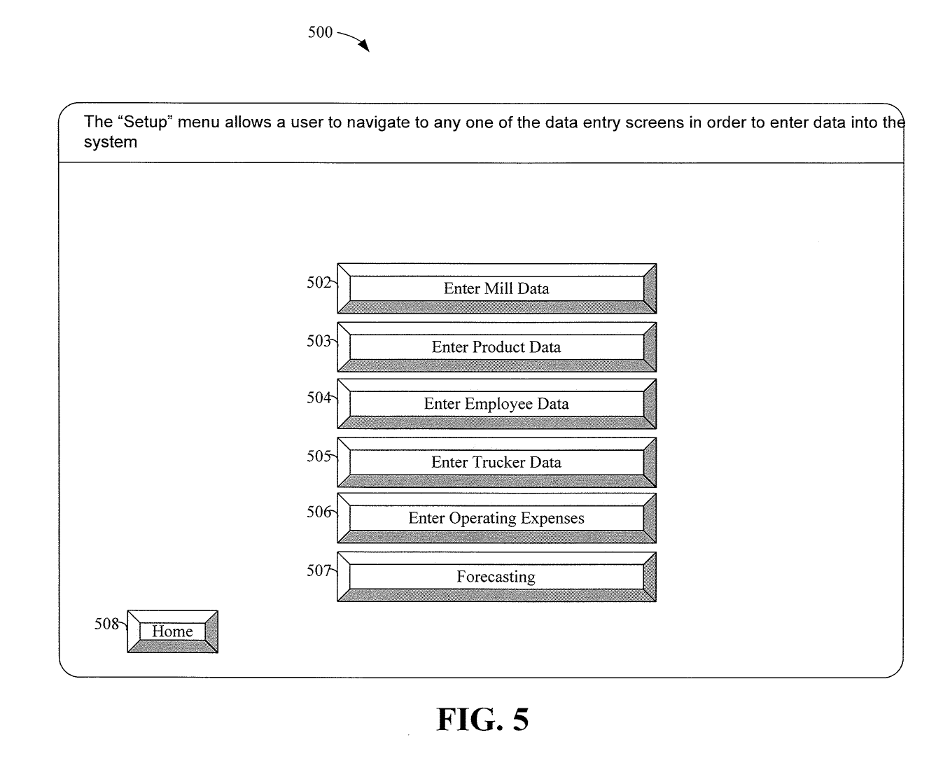

If the user selects pushbutton 402 (FIG. 4) in step 1000, the transaction tracking logic 202 displays the “Setup” GUI 500 (FIG. 5), and in step 1002, the transaction tracking logic 202 receives setup data 205 (FIG. 2) from the user, and in step 1003 the transaction tracking logic 202 stores the received setup data 205 in memory 201 (FIG. 1). From the “Setup” GUI 500, the user can select the “Home” pushbutton 407, and the transaction tracking logic 202 will display the “Home” GUI 400 at step 799.

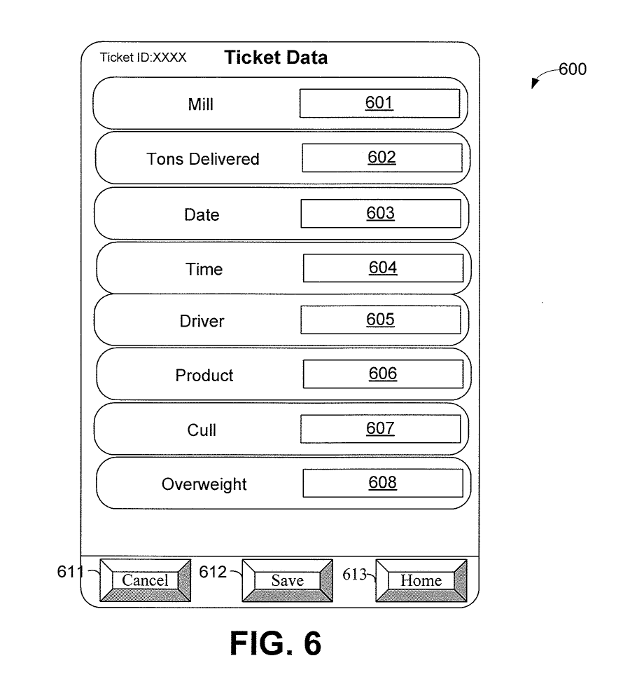

If the user selects pushbutton 403 (FIG. 4) in step 1001, the transaction tracking logic 202 displays the “Ticket Data” GUI 600 (FIG. 6). In step 1004, the transaction tracking logic 202 receives ticket data 206 (FIG. 2) from the user, and in step 1005 the transaction tracking logic 202 stores the received ticket data 206 in memory 201. From the “Ticket Data” GUI 600, the user can select the “Home” pushbutton 613, and the transaction tracking logic 202 will display the “Home” GUI 400 at step 799.

If the user selects pushbutton 404 (FIG. 4) in step 1006, the transaction tracking logic 202 displays the “Week-End Report” GUI 700 (FIG. 7). In step 1007, the transaction tracking logic 202 retrieves report data 219 (FIG. 2) from memory 201, and in step 1008 the transaction tracking logic 202 displays the retrieved report data 219 to the output device 209 (FIG. 2). Such information retrieved and displayed is shown in FIG. 7. In this regard, the transaction tracking logic 202 may display payments made to loggers on a particular job and/or the price per ton that is paid to the logger as shown in FIG. 7. From the “Week-End Report” GUI 700, the user can select the “Home” pushbutton 707, and the transaction tracking logic 202 will display the “Home” GUI 400 at step 799.

If the user selects pushbutton 405 (FIG. 4) in step 1009, the transaction tracking logic 202 displays a “Year-End Report” GUI (not shown). In step 1010, the transaction tracking logic 202 retrieves report data 219 (FIG. 2) from memory 201, and in step 1011 the transaction tracking logic 202 displays the retrieved report data 219 to the output device 209 (FIG. 2) indicative of year-end results of a plurality of transactions recorded throughout the year.

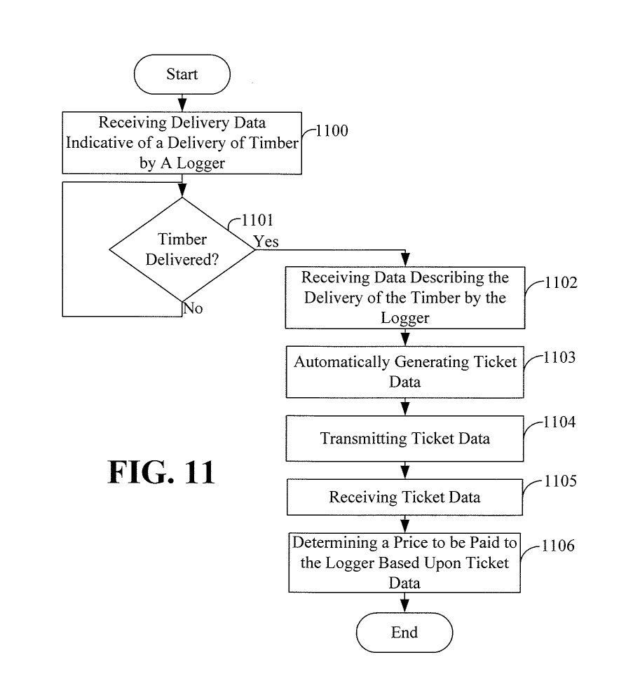

FIG. 11 is a flowchart depicting exemplary functionality and architecture of the system 100 (FIG. 1).

In step 1100, the mill computing device 115 is configured for receiving delivery data indicative of a delivery of timber by a logger. When the timber is delivered, in step 1101, the mill computing device 115 is configured for receiving data describing the delivery of the timber by the logger in step 1102.

In step 1103, the mill computing device 115 is configured for automatically generating ticket data indicative of the data describing the delivery. In step 1104, the mill computing device 115 is configured for transmitting the ticket data generated in step 1103 to the logger computing device 107.

In step 1105, the logger computing device is configured for receiving the ticket data, and in step 1106, the logger computing device is configured for determining a price to be paid to the logger based upon the ticket data received in step 1105.

What I claim is:

1. A transaction tracking system configured for tracking a transaction for harvesting timber, comprising:
a mill computing device configured for receiving delivery data indicative of a delivery of timber and for receiving data describing the delivery of the timber by a logger, the mill computing device further configured for transmitting ticket data indicative of the delivery of the timber by the logger; and
a logger computing device configured for receiving the data indicative of the ticket and determining, based upon the ticket data, a price to be paid to the logger.

2. The transaction tracking system configured for tracking a transaction for harvesting timber of claim 1, further comprising a timber buyer computing device configured for transmitting the deliver data to the mill computing device.

3. The transaction tracking system configured for tracking a transaction for harvesting timber of claim 2, wherein the delivery data comprises data indicative of a tonnage of timber to be delivered and a pre-agreed upon price per ton delivered to be paid to a timber buyer.

4. The transaction tracking system configured for tracking a transaction for harvesting timber of claim 1, further comprising a network wherein the mill computing device transmits the ticket data to the logger computing device via the network.

5. The transaction tracking system configured for tracking a transaction for harvesting timber of claim 4, wherein the logger computing device is further configured for receiving the ticket data via the network.

6. The transaction tracking system configured for tracking a transaction for harvesting timber of claim 6, wherein the logger computing device is further configured for calculating a price to be paid by a timber buyer to a logger.

7. The transaction tracking system configured for tracking a transaction for harvesting timber of claim 6, further comprising a timber buyer computing device, wherein the logger computing device is further configured for transmitting the ticket data to the timber buyer, and the timber buyer computing device is further configured for receiving the ticket data.

8. The transaction tracking system configured for tracking a transaction for harvesting timber of claim 7, wherein the timber buyer computing device is further configured for calculating the price to be paid the logger and automatically depositing in the logger's bank account a credit indicative of the calculated price.

9. The transaction tracking system configured for tracking a transaction for harvesting timber of claim 1, wherein the ticket data comprises data indicative of a mill, a tonnage of timber delivered by a logger, a cull, and an overweight amount.

10. A transaction tracking method for tracking a transaction for harvesting timber, comprising:
receiving, by a mill computing device, delivery data indicative of a delivery of timber by a logger;
receiving, by the mill computing device, data describing the delivery of the timber by the logger when the timber is delivered;
automatically generating ticket data indicative of the delivery;
transmitting the ticket data by the mill computing device;
receiving, by a logger computing device, the ticket data; and
determining, by the logger computing device, a price to be paid to the logger based upon the ticket data.

11. The transaction tracking method for tracking a transaction for harvesting timber of claim 10, further comprising transmitting the delivery data to the mill computing device by a timber buyer computing device.

12. The transaction tracking method for tracking a transaction for harvesting timber of claim 11, wherein the receiving the delivery data further comprises receiving delivery data indicative of a tonnage of timber to be delivered and a pre-agreed upon price per ton delivered to be paid to a timber buyer.

13. The transaction tracking method for tracking a transaction for harvesting timber of claim 11, further comprising transmitting the ticket data to the logger computing device via a network by the mill computing device.

14. The transaction tracking method for tracking a transaction for harvesting timber of claim 13, further comprising receiving the ticket data via the network by the logger computing device.

15. The transaction tracking method for tracking a transaction for harvesting timber of claim 14, further comprising calculating a price to be paid by a timber buyer to a logger by the logger computing device.

16. The transaction tracking method for tracking a transaction for harvesting timber of claim 15, further comprising:
transmitting the ticket data to the timber buyer by a logger computing device; and
receiving the ticket data by a timber buyer computing device.

17. The transaction tracking method for tracking a transaction for harvesting timber of claim 16, further comprising:
calculating the price to be paid the logger by the timber buyer computing device; and
automatically depositing in the logger's bank account a credit indicative of the calculated price.

18. The transaction tracking method for tracking a transaction for harvesting timber of claim 10, wherein the generating the ticket data comprises generating ticket data comprising data indicative of a mill, a tonnage of timber delivered by a logger, a cull, and an overweight amount.
